(19) United States
(12) Patent Application Publication
(10) Pub. No.: US 2017/0073248 A1
(43) Pub. Date: Mar. 16, 2017

(54) Method and System for Removing Radioactive Nuclides from Water

(71) Applicants: Martin Kaschek, St. Ingbert (DE); Behnaz Shoar, Saarbrucken (DE); Heiko Poth, Neunkirchen (DE); Kay Gunther Gabriel, Jeddah (SA)

(72) Inventors: Martin Kaschek, St. Ingbert (DE); Behnaz Shoar, Saarbrucken (DE); Heiko Poth, Neunkirchen (DE); Kay Gunther Gabriel, Jeddah (SA)

(73) Assignee: ItN Nanovation AG, Saarbrucken (DE)

(21) Appl. No.: 15/361,834

(22) Filed: Nov. 28, 2016

Related U.S. Application Data
(63) Continuation of application No. PCT/EP2014/061134, filed on May 28, 2014.

(51) Int. Cl. C02F 1/28; C02F 1/00; C02F 1/68; G21F 9/12; C02F 1/44

(52) U.S. Cl. CPC C02F 1/28; G21F 9/12; C02F 1/444; C02F 1/685; C02F 1/008; C02F 2101/006

(57) ABSTRACT

The present invention concerns a method for the removal of radionuclides from water, wherein at least one absorption additive that has an absorptive effect on the nuclides and at least one filter device that is impermeable to the adsorption additive and the nuclides absorbed thereon are used. An improved removal rate is achieved with reduced equipment expenditure when an adsorption layer is formed from the adsorption additive on an inflow-side surface of the respective filter device.

### CROSS-REFERENCE TO RELATED PATENT APPLICATIONS

This patent application is a continuation of International Application No. PCT/EP2014/061134, filed May 28, 2014, the entire teachings and disclosure of which are incorporated herein by reference thereto.

### FIELD OF INVENTION

The present invention concerns a method for the removal of radionuclides from water. The invention also concerns a system for the removal of radionuclides from water.

### BACKGROUND OF INVENTION

Water is a precious commodity in many countries, for example in numerous African and Arab countries in which costly measures must be taken in order to meet the need for drinking and process water. In some countries, considerable amounts of water are pumped from deep wells or produced by seawater desalination plants. However, a problem in this connection is that water from deep wells is often contaminated with very high concentrations of radionuclides and heavy metal salts such as iron salts and manganese salts. In particular, water from deep wells contains the isotopes ²²⁶Ra and ²²⁸Ra, but also ²²⁸Th, which is part of the same decay chain, where Ra denotes radium and Th thorium. These radionuclides are formed in particular by the decay of naturally occurring uranium. In deep ground water, radionuclides are generally present both in the form of dissolved ions and bound to tiny suspended minerals. Water containing radionuclides may also be referred to in the following as contaminated water. Product water produced by means of a method or system of the type mentioned above from which radionuclides have largely been removed may therefore also be referred to as decontaminated water. Product water can then be used as drinking water or process water or further processed into drinking water or process water.

Deep ground water can generally be purified by means of reverse osmosis methods, which allow large amounts of the load contained in the water to be removed. In order to prevent the reverse osmosis membranes used in these methods from being overloaded, purification by reverse osmosis is usually preceded by several pre-purification steps. For example, these may be filtration steps by means of which the aforementioned suspended particles and precipitated heavy metal compounds contained in the water, as well as the radionuclides bound thereto, are to be removed.

For example, sand filters may be used for such filtration tasks. Such sand filters have various drawbacks. After a few months, the amounts of radionuclides accumulating in sand filters are so great that they must be replaced. Regeneration of the filters is not feasible. The disposal thereof is problematic based only on the extraordinarily large amounts of contaminated sand involved.

Moreover, the radionuclides contained in deep ground water, such as radium or thorium ions, cannot be sufficiently removed by a sand filter alone. Attempts are therefore made to precipitate the radionuclides by chemical means before the deep ground water enters the sand filter. The resulting radioactive precipitates can then be retained by the sand filter. For example, water-soluble barium salts such as barium chloride can be used to cause precipitation of radionuclides. However, barium chloride is a comparatively toxic and costly chemical.

A method and system for the removal of radionuclides from water of the aforementioned type are known from WO 2013/034442 A1. In the generic method, both an adsorption additive that has an absorptive effect on the nuclides and a filter device that is essentially impermeable to the adsorption additive and nuclides adsorbed thereto are used. In the known method, the most commonly used adsorption additive is manganese dioxide. The known system comprises at least one filtering station, which contains at least one filter device in a filter tank through which water can flow. The known system also comprises at least one dosing device for addition of the adsorption additive to the water flow. In the known system, addition of the adsorption additive to the water flow takes place inside a mixer with a downstream mixing tank of a mixing station upstream from the filtering station. Inside the mixing tank, the water flow has a relatively long residence time, which is required for homogeneous distribution of the adsorption additive in the water flow. Homogeneous distribution of the adsorption additive in the water flow facilitates adsorption of the nuclides contained therein. In the known system or the known method, removal of the nuclides from the water is carried out in such a way that the nuclides accumulate on the adsorption additive inside the mixing tank, i.e. upstream from the respective filter device. For this purpose, the adsorption additive must be continuously added to the water flow in the mixing station. This addition takes place, for example, at a maximum concentration of 10 ppm. The long residence time in the mixing station makes it possible for the adsorption additive to adsorb a high percentage of the nuclides contained in the water. In the subsequent filtering station, the adsorption additive is filtered out together with the nuclides adsorbed thereto. In this case, a so-called filter cake (“cake layer”) may form on an inflow-side surface of the respective filter device that uniformly and slowly increases through the entire filtration process and is composed of accumulated removed impurities, i.e. primarily the adsorption additive with adsorbed nuclides and any other particulate impurities that may be contained in the water. In the known method, adsorption of the nuclides to the absorption additive therefore takes place in the mixing station and thus upstream from the filtering station.

Using this type of conventional system or conventional method, it is currently possible to remove a maximum of 80% of the nuclides from the water in a single-stage process. Further measures are therefore necessary for drinking water quality. In particular, the method can be conducted in several stages, i.e. used multiple times, in order to achieve a desired high filtration. Accordingly, the known method and systems are relatively difficult to implement.

Moreover, known methods and systems take as a point of departure that the total water flow used in pre-treatment, in which the nuclides are absorbed using the adsorption additive, is subjected to uniform treatment. The result is that for the process as a whole, it is only possible to achieve identical water quality levels. Using conventional methods or systems, partial flow treatment with different removal rates of the respective nuclides according to requirements is either impossible or only possible with a high degree of technical expenditure.

A residence time in the respective mixing tank of approx. 30 min. is required in order to achieve optimally thorough mixing and adsorption of the nuclides, which means that the mixing tank must have correspondingly large dimensions depending on the volume of the water flow to be purified. This causes a corresponding increase in the expense of implementing this type of system.

### BRIEF SUMMARY OF THE INVENTION

The present invention concerns the problem of providing an improved embodiment of a method or system of the type described above, characterized in particular by especially high separation efficiency and/or simplified implementability.

This problem is solved by the subject matter of the independent claims. Advantageous embodiments are the subject matter of the dependent claims.

The invention is based on the general idea of carrying out adsorption of the nuclides to the adsorption additive directly in the respective filter device, with an adsorption layer being produced from an adsorption additive on an inflow-side surface of the respective filter device. In this case, the adsorption layer can be produced in the form of a filter cake, with the adsorption additive being added to a water flow flowing through the respective filter device upstream from said respective filter device. During operation of the respective system, or while the method is being carried out, the contaminated water first flows through the adsorption layer and then through the filter device. As the water flows through the adsorption layer, the nuclides contained therein are adsorbed, while the respective filter device retains the adsorption additive with the accumulated nuclides in the adsorption layer.

In this method, the adsorption layer, at least at the beginning of a filtration phase of the filtration process, is largely composed of the adsorption additive, i.e. at least to 50%, preferably to at least 75%, and particularly preferably to at least 90%. Other components of the adsorption layer can consist of suspended particles that may also be contained in the water flow. The adsorption additive in this case is a single chemical or a mixture of at least two different chemicals, with the respective chemical having an adsorptive effect on the respective nuclide. For example, a conceivable option is a mixture of chemicals that have adsorptive effects on different nuclides. In this case, a multiple-layer adsorption layer is particularly advantageous. For example, a first layer could be applied to the inflow-side surface that is composed of the respective adsorption additive having an adsorptive effect on the interfering nuclides, while a second layer could then be applied to the first layer, said second layer being composed of another chemical that can adsorb other substances contained in the water, such as substances that could have an effect of interfering with adsorption of the nuclides.

There is an extremely high concentration of the adsorption additive in this adsorption layer, so that when water contaminated with radionuclides flows through the adsorption layer, the nuclides are efficiently adsorbed. According to the invention, adsorption of the nuclides is thus shifted to the area of the respective filter device, specifically to the respective adsorption layer. In this manner, the respective filter device acts as an adsorption filter.

Therefore, in the method according to the invention or the system according to the invention, one can generally dispense with the upstream mixing station used to provide a relatively long residence time of the water flow in a corresponding mixing tank so as to provide sufficient homogenization for the desired adsorption taking place inside the mixing tank. The equipment expenditure that would be required for such a mixing station is not needed in the invention. Specifically, the system according to the invention is characterized in that the dosing device adds the adsorption additive to the water flow inside a filter tank, i.e. immediately upstream from the respective filter device. No residence time is required. However, it is advantageous to apply the adsorption layer as evenly as possible to the entire inflow-side surface of the respective filter device.

It has also been found that the method according to the invention makes it possible to achieve markedly higher separation efficiency. In experiments, separation efficiency was achieved of more than 90% and in some cases even more than 95%. This is explained by the fact that in the adsorption layer through which contaminated water flows, the migration paths of the nuclides to the adsorption additive that are sufficient to almost completely remove the nuclides contained in the water are extremely short.

Thus, in the method according to the invention, contaminated water in the form of a water flow is added to the respective filter device. This water flow flows through the respective filter device and thus necessarily also through the adsorption layer, allowing the nuclides contained in the water to be largely adsorbed by the adsorption additive. Decontaminated water can therefore be discharged by the respective filter device.

According to an advantageous embodiment, the adsorption layer is produced from the adsorption additive, which is essentially free of nuclides. Additionally or alternatively, an embodiment can be provided in which the adsorption layer is produced from an adsorption additive that is at least 50%, preferably at least 75%, and particularly preferably at least 90% free of nuclides. This means that in such cases, the adsorption additive is added to the water flow in such a manner that there is essentially no time left before accumulation at the respective filter device that would be sufficient for adsorption of nuclides that might be contained in the water flow. Independently of this, it is also feasible to produce the absorption layer by means of a water flow consisting of purified water, i.e. water that contains no or essentially no radionuclides. In this manner, a particularly strong adsorptive effect for the nuclides contained in the water is achieved in the adsorption layer.

According to another advantageous embodiment, the method can be carried out in such a way that adsorption of the nuclides takes place during a filtration phase of a filtration process largely or essentially in the adsorption layer. Additionally or alternatively, an embodiment can be provided in which at least 50%, preferably at least 75%, and particularly preferably at least 90% of nuclide adsorption takes place during a filtration phase of a filtration process in the adsorption layer. Adsorption of the nuclides preferably does not occur during the filtration phase until the water reaches the adsorption layer or occurs exclusively in this layer. This method makes it possible to largely or completely dispense with adsorption of nuclides in the water flow upstream from the filter device. In this case, adsorption takes place largely or completely when the water flows through the adsorption layer.

According to another advantageous embodiment, production of the adsorption layer can take place during a start phase of a filtration process, specifically by means of adding the adsorption additive to water flowing through the respective filter device. The filtration process comprises, in addition to the start phase, a filtration phase following the start phase that is longer than the start phase. The filtration phase should preferably be at least 10 times, and preferably at least 100 times longer than the start phase. In the filtration phase, contaminated water then flows through the adsorption layer, with the nuclides largely being adsorbed by the adsorption additive. The water flow to which the adsorption additive is added during the start phase to produce the adsorption layer may consist of the contaminated water to be purified, and it is also possible in this case to use already purified water that contains no or essentially no nuclides.

In an advantageous improvement, the adsorption additive is added to the water flow largely or essentially only during the start phase. Additionally or alternatively, an embodiment can be provided in which at least 50%, preferably at least 75%, and particularly preferably at least 90% of the entire amount of adsorption additive used during a filtration process is contained in the adsorption layer. This means that relatively little to no adsorption additive is added to the water flow during the filtration phase.

Provided that addition of the adsorption additive to produce the adsorption layer takes place exclusively during the start phase, the method according to the invention involves discontinuous addition of the adsorption additive, i.e. only during the start phase. In contrast, known conventional methods that involve a mixing station upstream from the filtration station are characterized by continuous addition of the adsorption additive. It has been found that in the method according to the invention, a lower total amount of adsorption additive is required to purify a predetermined amount of water, said additive being discontinuously added during the start phase, than is required in a conventional method in which the adsorption additive is added continuously throughout the entire filtration process.

According to another advantageous embodiment, the adsorption additive for producing the adsorption layer may be added to water flowing through one of the respective filter devices at a concentration of at least 50 ppm, advantageously at least 100 ppm, preferably at least 500 ppm, and particularly preferably at least 1000 ppm. In contrast to this, in known methods involving continuous addition of the adsorption additive, the adsorption additive must be added at a maximum concentration of 10 ppm. In other words, in order to produce the adsorption layer, the adsorption additive must be added to the water flow in a percentage that is much greater than that required for adsorption of the nuclides upstream from the filter device. The use of this high concentration makes it possible to build up the adsorption layer relatively quickly, so that the start phase can be correspondingly short. In this case, addition of the adsorption additive at the aforementioned high concentration takes place in the start phase during a predetermined dosing period that can be shorter than the start phase, but also as long as the start phase.

In a preferred embodiment, at least one ceramic filter membrane can be used in the respective filter device. This embodiment is based on the finding that other filter materials, for example plastic filter membranes or sand filters, are unsuitable for the high concentrations of the adsorption additive that can be used in the method according to the invention to produce the adsorption layer.

In an advantageous embodiment, the adsorption additive may be a solid having a granulate-like or flake-like structure or consist largely of such a solid. The solid used may be solid or porous. Use of such a particle-shaped or particulate solid as an adsorption additive is advantageous in that the adsorption layer itself has a porous structure, making it easy for water to flow through it and making the available adsorption surface extremely large, which favors rapid adsorption. In this case, the average particle size in the adsorption layer is preferably larger than the average inflow-side particle size of the filter material used in the respective filter device, such as a ceramic filter membrane.

The system according to the invention is characterized in that the respective dosing device adds the adsorption additive during operation of the system, specifically during the start phase, to the water flow inside the respective filter tank or immediately upstream thereof, i.e. immediately upstream from the respective filter device, so that the desired adsorption layer can form in the filter device on the inflow side. The adsorption additive can also be added e.g. via a supply line that feeds the contaminated water to the respective filter tank. During operation of the system, contaminated water is added to the respective filtering station or the respective filter tank, and decontaminated water is discharged from the respective filtering station or the respective filter device. The system presented here therefore generally allows the addition of the adsorption additive without a mixing station configured upstream from the respective filtering station that has a mixer and a mixing tank.

In an advantageous improvement of the system, at least two filtering stations may be provided, specifically at least one main flow filtering station and at least one secondary flow filtering station. The dosing device can advantageously be configured in such a way that it can add the adsorption additive to the water flow inside the respective filter tank of the two filtering stations at individual dosages, and specifically in such a way that the filtration rate produced in the respective main flow filtering station is different from that in the respective secondary flow filtering station. The main flow is characterized by having a different, generally larger volume than the secondary flow. In a feasible example, the removal rate produced in the main flow is less than in the secondary flow, with it being possible to subsequently mix the auxiliary flow with the main flow in order to achieve a desired target removal rate in the mixed flow, a process referred to as “blending.” By adjusting the distribution of the main flow and auxiliary flow, the same high target filtration rate can consistently be achieved in the product water, i.e. in the decontaminated water, even if the raw water, i.e. the contaminated water, has a varying degree of contamination. Different uses for the main flow and the secondary flow are also possible.

In another improvement, a control device for operating the system can be provided that is connected at least to the respective dosing device and is configured or programmed in such a way that it can carry out the above-described method according to the invention during operation of the system.

The method according to the invention takes as a point of departure that adsorption of the nuclides is directly combined with filtration. For this purpose, said absorption layer is generated completely on the inflow-side surface of the respective filter device at the beginning of filtration, i.e. during a start phase. In this case, dosing or mixing in of the respective adsorption additive, which should preferably be a particulate adsorption chemical, i.e. a chemical composed of solid particles (granulate), takes place within a relatively short period, which can last several minutes. Uniform, continuous dosing throughout the entire filtration process should preferably not be conducted or is not required. Within a short time, the desired adsorption layer can form. The absolute amount of adsorption additive required for this is comparable to and preferably even less than that used in conventional continuous dosing. The adsorption additive is added in such a way that it cannot be prematurely distributed into the water flow to be treated so that the adsorption surface of the adsorption additive during formation of the adsorption layer on the inflow-side surface of the respective filter element is still clear, i.e. free of nuclides and interfering substances. In this manner, interfering processes caused by undesired adsorption of competing substances can be minimized. The contaminated water to be filtered must pass through the pores of the adsorption layer before reaching the inflow-side surface of the respective filter device. The pores of the adsorption layer may be larger than the corresponding pores of the respective filter device. For example, the pores of the adsorption layer may measure a few pm, while the pores of the filter device are in the range of 10 nm to 600 nm, and preferably approx. 200 nm. The thickness of the adsorption layer may be from 0.1 mm to a few mm, preferably less than 10 mm.

For adding the adsorption additive, a central dosing device may be used that makes it possible to carry out individual dosing specifically for each filtration flow, i.e. individually for each filtering station. In this manner, different removal rates in the water treatment system can also be achieved in a single-stage process. This is highly advantageous in that specified partial flows can be directly used as partial product flows without further treatment. For example, a blending flow with high removal rates is feasible. Other partial flows that are provided for further treatment and further removal of other harmful substances or other impurities, for example by means of an upstream reverse osmosis device, can be fed into the respective filtration tanks with a lower dose of the adsorption additive. As a result, operating costs can be reduced, as less adsorption additive is used overall.

As an adsorption additive, one can use manganese oxide and/or manganese dioxide, or a chemical that produces manganese oxide and/or manganese dioxide in the water in situ. Additionally or alternatively, iron oxide can generally be used as well. The preferred adsorption additive, i.e. manganese oxide and/or manganese dioxide and/or iron oxide, can be directly added to the contaminated water. In a particularly advantageous embodiment, the respective adsorption additive is present in the form of a porous precipitate having a particularly large inner surface. For example, the specific surface area may be greater than 350 m²/g, as determined by PET. As manganese dioxide ages and loses porosity in the process, it should be produced whenever possible immediately prior to addition.

The manganese oxide and/or manganese dioxide used is preferably obtained by oxidation from an aqueous manganese salt solution adjusted to a pH of between 4.5 and 9, and preferably between 7 and 9. An example of a suitable manganese salt is manganese sulfate. An example of a suitable oxidant is potassium permanganate or sodium hypochlorite. It is also possible to adjust the potassium permanganate to a basic pH, for example with NaOH, and add the basic potassium permanganate to a slightly acidic manganese salt solution. This makes it possible to better control the stoichiometry of the reaction.

In another embodiment, the contaminated water can be chemically treated, for example by adding barium salt. Barium salt can promote the precipitation of radium. In this case, the barium salt can be added to the water flow upstream from the filter device. It is also possible to add barium salt during production of the adsorption layer so that it is contained in the adsorption layer in a corresponding percentage.

Moreover, the addition of other chemicals such as ozone or atmospheric oxygen is also possible, e.g. in order to oxidize other metals and metal ions contained in the water, for example in order to separate iron by oxidation.

A ceramic filter membrane that is preferably used in the respective filter device can be specifically configured as a microporous filter membrane. The respective ceramic filter membrane should preferably be a flat membrane plate with interior filtrate discharge channels and an external porous separating layer on the inflow-side surface. Such membranes are described in detail in DE 10 2006 008 453 A1, which is incorporated in its entirety herein by reference. In the present method, ceramic filter membranes should preferably be used in which the pores, at least on the inflow-side surface, and particularly in the aforementioned separating layer, have an average diameter between 80 nm and 800 nm, and preferably between 100 nm and 300 nm.

It is particularly advantageous to use plate-shaped filter membranes that can be combined into filter units, such as described in WO 2010/015374 A1, which is incorporated in its entirety herein by reference.

Ceramic filter membranes can preferably be used at a negative pressure of 100 mbar to 600 mbar so that the decontaminated product water is suctioned in through the respective filter membrane. However, it is also possible to use the ceramic filter membrane at a positive pressure, so that the contaminated water is pressed through the filter membrane.

It is also particularly advantageous to use an adsorption additive that itself is present in the form of a particulate solid. This applies in particular to the aforementioned manganese oxide and/or manganese dioxide and/or iron oxide. Accordingly, the adsorption layer on the inflow-side surface of the respective filter device is itself porous, with it not being possible for adsorption of the nuclides to cause any essential blockage of this porosity. Therefore, the suitably applied adsorption layer can by no means cause clogging of the respective filter device. Rather, a constantly high flow can be achieved without clogging of the filter device by the adsorption layer.

Other important characteristics and advantages of the invention are specified in the subclaims, the drawings, and the accompanying description of the figures with reference to the drawings.

It is to be understood that the aforementioned characteristics and those to be explained below can be used not only in the specified combinations, but also in other combinations or alone, without departing from the scope of the present invention.

Preferred embodiments of the invention are presented in the drawings and will be explained in further detail in the following description, with the same reference numbers referring to the same, similar, or functionally equivalent components.

### BRIEF DESCRIPTION OF THE SEVERAL VIEWS OF THE DRAWING

The figures are schematic representations of the following:

FIG. 1 shows a highly simplified, circuit diagram-like schematic representation of a system for removal of radionuclides from water, and

FIG. 2 shows a highly simplified sectional view of a filter device in the area of an adsorption layer.

### DETAILED DESCRIPTION OF THE INVENTION

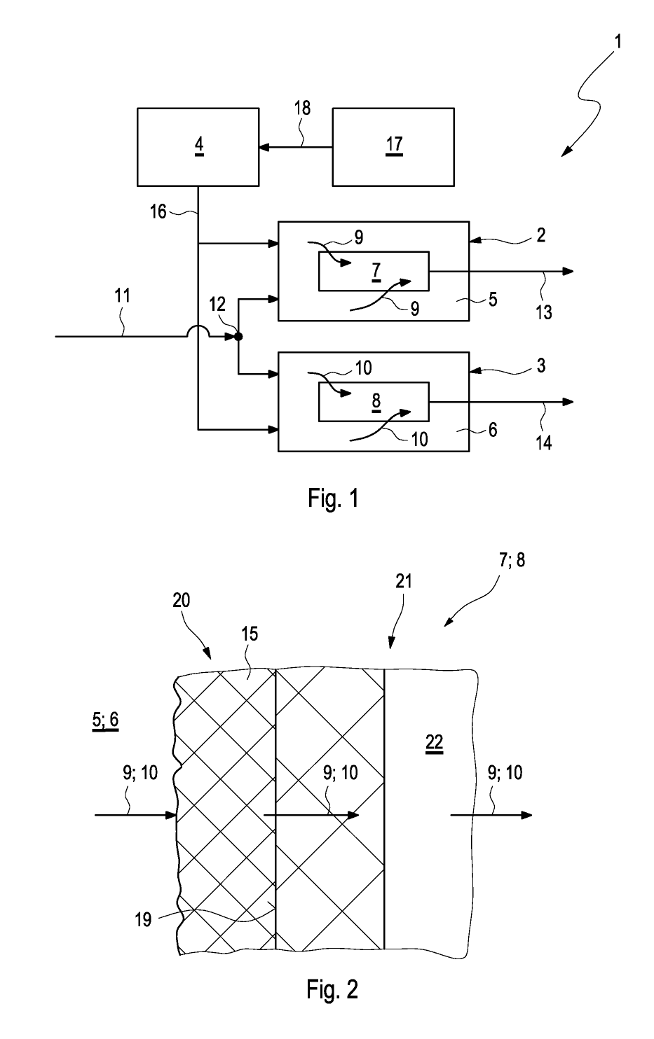

As shown in FIG. 1, a system 1 by means of which radionuclides such as radium isotopes can be removed from water, for example in order to produce drinking water or process water, comprises at least one filtering station 2, 3 and at least one dosing device 4. In the example of FIG. 1, two such filtering stations 2, 3 having a common dosing device 4 are shown purely by way of example. Another system 1 can also function with only a single filtering station 2, 3 or have more than two filtering stations 2, 3. Several dosing devices 4 may also be provided.

Each of the respective filtering stations 2, 3 has a filter tank 5 or 6 in each of which at least one filter device 7 or 8 is configured. In this case, a water flow 9 or 10 indicated by an arrow can flow through each of the respective filter devices 7, 8. The water flows 9, 10 are supplied via a common supply line 11 that branches at 12 in order to feed contaminated water, i.e. water containing radionuclides, to the filter tanks 5, 6 in parallel. Separate lines 13, 14 leading away are used to discharge the purified water, i.e. the decontaminated water or product water, from the filter devices 7, 8.

The dosing device 4 is configured in such a way that it can add an absorption additive 15 indicated in FIG. 2 to the water flows 9, 10 upstream from the filter devices 7, 8. The dosing device 4 can add the adsorption additive 15 to the respective water flow 9, 10 inside the respective filter tank 5, 6. A corresponding dosing line 16 of the dosing device 4 is directly attached to the respective filter tank 5, 6. The respective filter device 7, 8 is adjusted with respect to its filtration effect or particle size in such a way that it is permeable to water and essentially impermeable to the adsorption additive 15 and the nuclides accumulated thereon.

Provided that, as shown in FIG. 1, at least two filtering stations 2, 3 are configured, the one filtering station 2 can serve as the main flow filtering station 2, while the other filtering station 3 serves as a secondary flow filtering station 3. The dosing device 4 can separately add the required amount of adsorption additive 15 to the separate filtering stations 2, 3 or supply it to the respective filter tank 5, 6. It is advantageous to carry out dosing of the adsorption additive 15 to the two filter tanks 5, 6 individually in such a way that different filtration rates can be set at the two filtering stations 2, 3.

For operation, the system 1 should preferably be equipped with a control device 17 that is attached for example via a control line 18 to the dosing device 4. The control device 17 should preferably be configured or programmed in such a way that it can carry out the method for the removal of radionuclides from water explained in detail above and summarized below while the system 1 is in operation.

In order to remove the nuclides from the contaminated water, for example in order to produce product water that can be used as drinking or process water or is to be processed into drinking or process water, the adsorption additive 15 is configured in the filter tanks 5, 6 in such a way that an absorption layer 20 is formed from the adsorption additive 15 as shown in FIG. 2 on an inflow-side surface 19 of the respective filter device 7, 8. The adsorption layer 20 is produced from the adsorption additive 15, which is essentially still free of nuclides, so that absorption of the nuclides essentially takes place during a filtration phase of a filtration process only when it reaches the adsorption layer 20, and preferably exclusively in said layer.

For example, this kind of adsorption layer 20 can be produced by adding the adsorption additive 15 during a start phase of the filtration process to the respective water flow 9,10 flowing through the respective filter device 7, 8. During the start phase, the respective water flow 9, 10 cannot be composed of uncontaminated or already purified water. However, it is generally possible to use contaminated raw water during the start phase in order to apply the adsorption layer. By addition of the adsorption additive 15 to the water flow 9, 10 flowing through the respective filter device 7, 8, the adsorption layer 20 automatically forms as a filter cake on the inflow-side surface 19 of the respective filter device 7, 8. Addition of the adsorption additive 15 to the respective water flow 9, 10 or the respective filter tank 5, 6 should preferably be carried out in such a way that to the extent possible, the entire inflow-side surface 19 of the respective filter device 7, 8 is loaded as uniformly as possible with the adsorption additive 15. The start phase can last a few minutes. In any case, the start phase is much shorter than the subsequent filtration phase, in which the nuclides can be removed from the contaminated water by the adsorption layer 20.

Addition of the adsorption additive to the water flow 9, 10 should preferably be carried out exclusively during the aforementioned start phase so that no addition of the adsorption additive 15 takes place during the much longer filtration phase in particular. The addition of the respective adsorption additive 15 during the start phase or during a dosing period within the start phase is carried out at a relatively high concentration, which for example can be at least 50 ppm or at least 100 ppm, preferably at least 500 ppm, and particularly preferably at least 1000 ppm. Here, the absolute amount of the adsorption additive depends on the contamination of the raw water, the volume flow of the raw water, and the absolute amount of the raw water to be purified during the filtration process. At the end of the filtration process, the adsorption layer 20 should ideally be almost saturated with the adsorbed nuclides. For a new filtration process, the respective filter device 7, 8 may be regenerated, for example by means of backflushing, in which the exhausted or used adsorption layer 20 is rinsed off the inflow-side surface of the filter device 7, 8. After this, a new, unused adsorption layer 20 can be applied in a new start phase.

In a particularly advantageous embodiment, the filter device 7, 8 is equipped with at least one ceramic filter membrane 21 that has at least a part of the inflow-side surface 19 of the respective filter device 7, 8. According to FIG. 2, the filter membrane 21 has at least one internal channel 22 through which the purified water flow 9, 10 enters and from which the purified water flow 9, 10 can be discharged from the respective filter device 7, 8. The filter membrane 21 should preferably have a particle size in the single- or double-digit nm range.

As an absorption additive 15, a solid is preferably used that is granular or floccular, i.e. is used in the form of particles. The solid used may be solid or porous. This provides the adsorption layer 20 with a porous structure. The porosity of the absorption layer 20 is preferably within the single- or double-digit pm range. The porosity of the adsorption layer 20 can generally also be less than that of the filter membrane 21.

Purification or decontamination of the water is conducted by means of adsorption of the nuclides to the adsorption additive 15 that takes place while the water flows through the adsorption layer 20 in such an efficient manner that an adsorption rate of at least 90% to 95% can be achieved.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Method for the removal of radionuclides from water,
wherein at least one absorption additive that has an absorptive effect on the nuclides is used, and
wherein at least one filter device that is impermeable to the respective adsorption additive is used,
characterized in that
an adsorption layer is produced from the adsorption additive on an inflow-side surface of the respective filter device.

2. Method as claimed in claim 1,
characterized in that
the adsorption layer is produced from an adsorption additive that is essentially free of nuclides.

3. Method as claimed in claim 1,
characterized in that
the adsorption layer is produced from an adsorption additive that is at least 50% free of nuclides.

4. Method as claimed in claim 1,
characterized in that
adsorption of the nuclides takes place during a filtration phase of a filtration process largely or essentially in the adsorption layer.

5. Method as claimed in claim 1,
characterized in that
at least 50% of adsorption of the nuclides takes place during a filtration phase of a filtration process in the adsorption layer.

6. Method as claimed in claim 1,
characterized in that
production of the adsorption layer takes place during a start phase of a filtration process by means of addition of the adsorption additive to a water flow flowing through the respective filter device.

7. Method as claimed in claim 6,
characterized in that
the adsorption additive is added to the water flow largely or essentially only during the start phase.

8. Method as claimed in claim 1,
characterized in that
at least 50% of the total adsorption additive used during a filtration process is contained in the adsorption layer.

9. Method as claimed in claim 1,
characterized in that,
in order to produce the adsorption layer, the adsorption additive is added to a water flow flowing through one of the respective filter devices at a concentration of at least 50 ppm.

10. Method as claimed in claim 1,
characterized in that
at least one ceramic filter membrane is used in the respective filter device.

11. Method as claimed in claim 1,
characterized in that
the adsorption additive is a particulate solid.

12. System for removal of radionuclides from water,
having at least one filtering station that contains at least one filter device in a filter tank, through which a water flow can flow, and
having at least one dosing device for addition of an adsorption additive to the water flow,
characterized in that
the respective dosing device is arranged and/or configured in such a way that it can add the adsorption additive to the water flow inside the respective filter tank or immediately upstream thereof.

13. System as claimed in claim 12,
characterized in that
at least two filtering stations are provided, specifically at least one main flow filtering station and at least one secondary flow filtering station, and
the dosing device for addition of the adsorption additive to the water flow inside the respective filter tank of the at least two filtering stations is configured in such a way that a filtration rate is produced in the respective main flow filtering station that is different from that in the respective secondary flow filtering station.

14. System as claimed in claim 12,
characterized by having a control device for operating the system that is connected to the respective dosing device and is configured and/or programmed so that during operation of the system, it carries out a method for the removal of radionuclides from water,
wherein the absorption additive has an absorptive effect on the nuclides, and
wherein the filter device is impermeable to the adsorption additive,
characterized in that
an adsorption layer is produced from the adsorption additive on an inflow-side surface of the filter device.
